(19) United States
(12) Patent Application Publication
(10) Pub. No.: US 2015/0048994 A1
(43) Pub. Date: Feb. 19, 2015

(54) ANTENNA MODULE AND MANUFACTURING METHOD THEREOF

(71) Applicant: DAE SAN ELECTRONICS CO., LTD., Hwaseong-si (KR)

(72) Inventors: Sang Young MA, Ansan-si (KR); Ju Young MA, Ansan-si (KR)

(73) Assignee: DAE SAN ELECTRONICS CO., LTD., Hwaseong-si (KR)

(21) Appl. No.: 14/461,785

(22) Filed: Aug. 18, 2014

(30) Foreign Application Priority Data
Aug. 19, 2013 (KR) 10-2013-0097801
Aug. 19, 2013 (KR) 10-2013-0097810
Feb. 24, 2014 (KR) 10-2014-0021345
Apr. 17, 2014 (KR) 10-2014-0045837

(51) Int. Cl. H01Q 1/40

(52) U.S. Cl. CPC H01Q 1/40
USPC 343/873; 29/600

(57) ABSTRACT

An antenna module includes: a first injection-molded part which is formed to have a base portion and a protrusion portion to be protruded from the base portion by an injection molding; an antenna pattern which is positioned on the protrusion portion; and a second injection-molded part which is formed to cover the antenna pattern by an injection molding. Since the antenna pattern is formed on the protrusion portion of the first injection-molded part, the thickness of a portion of the second injection-molded part on the antenna pattern can be minimized, and accordingly the antenna module and the mobile terminal case can be formed to be thin, light-weight and slim while the transmitting/receiving efficiency of the antenna can be maximized.

### TECHNICAL FIELD

The present invention relates to an antenna module and a manufacturing method thereof.

### BACKGROUND ART

Generally, an antenna module for a mobile terminal such as a cellular phone, a PDA, a laptop computer, and a DMB is installed therein, or connected or attached to a case thereof. In order to enhance a transmitting/receiving efficiency of an antenna, it is necessary that an antenna is disposed outside the mobile terminal to be maximally apart from a main board of the mobile terminal. However, there is a limitation in making an antenna module or a case of a mobile terminal to be thin, so there is a problem in that the transmitting/receiving efficiency of an antenna is deteriorated.

### DETAILED DESCRIPTION OF THE INVENTION

### Technical Problem

The present invention has been made in an effort to provide an antenna module and a manufacturing method thereof in which a thickness of a second injection-molded part can be minimized.

Further, the present invention has been made in an effort to provide an antenna module and a manufacturing method thereof in which flowing of resin during a second injection molding can become easy.

### Technical Solution

An antenna module according to an exemplary embodiment of the present invention includes: a first injection-molded part which is formed to have a base portion and a protrusion portion to be protruded from the base portion by an injection molding; an antenna pattern which is positioned on the protrusion portion; and a second injection-molded part which is formed to cover the antenna pattern by an injection molding.

The first injection molded-part may be formed in an insert injection molding using the antenna pattern.

The antenna pattern may be formed by irradiating a laser on a top of the protrusion portion and coating metal material on an area where the laser is irradiated or by printing an electrically conductive material on the top of the protrusion portion.

The protrusion portion may be formed by a combination of a curved surface portion and a planar surface portion.

The curved surface portion may include an upper curved surface portion which is adjacent to the antenna patter and is formed at a periphery of the protrusion portion.

The curved surface portion may further include a lower curved surface portion which is adjacent to the base portion and is formed at the periphery of the protrusion portion.

The protrusion portion may be formed such that an area of a section perpendicular to a protrusion direction of the protrusion portion decreases as it goes toward the protrusion direction of the protrusion portion from the base portion.

The area of the perpendicular section may nonlinearly decrease.

The area of the perpendicular section may linearly decreases.

The antenna pattern may include at least one of a main antenna for transmitting/receiving, an LTE antenna, a GPS antenna, a Bluetooth antenna, a sub antenna, and a Wi-Fi antenna.

An edge protrusion portion may be formed by being upwardly protruded at an edge area of the first injection-molded part.

The second injection-molded part may be formed by an injection molding in a state the formed first injection-molded part is not separated from a base mold.

A method for forming an antenna module according to an exemplary embodiment of the present invention includes: forming a first injection-molded part by an insert injection molding using an antenna pattern; and forming a second injection-molded part which covers the antenna pattern by an injection molding. The first injection-molded part comprises a base portion and a protrusion portion which is protruded from the base portion, and the antenna pattern is formed on the protrusion portion.

The second injection-molded part may be formed by an injection molding in a state that the formed first injection-molded part is not separated from a base mold.

A hole may be provided to the antenna pattern, and the base mold is provided with a position fixing pin which is inserted into the hole during the insert molding to fix position of the antenna pattern.

The base mold may be provided with a supporting protrusion pin which supports the antenna pattern during the insert molding.

A method for forming an antenna module according to another exemplary embodiment of the present invention includes: forming a first injection-molded part having a base portion and a protrusion portion which is protruded from the base portion; forming an antenna pattern on the protrusion portion; and forming a second injection-molded part which covers the antenna pattern by an injection molding.

The antenna pattern may be formed by irradiating a laser on a top of the protrusion portion and coating metal material on an area where the laser is irradiated or by printing an electrically conductive material on the top of the protrusion portion.

The second injection-molded part may be formed by an injection molding in a state the formed first injection-molded part is not separated from a base mold.

### Advantageous Effects

According to the present invention, since the antenna pattern is formed on the protrusion portion of the first injection-molded part, the thickness of a portion of the second injection-molded part on the antenna pattern can be minimized, and accordingly the antenna module and the mobile terminal case can be formed to be thin, light-weight and slim while the transmitting/receiving efficiency of the antenna can be maximized.

Further, since the protrusion portion is formed as a combination of a planar surface portion and a curved surface portion, the flowing of resin can be easier and accordingly the defect of an injection molding such as a burr can be minimized.

### BRIEF DESCRIPTION OF DRAWINGS

FIG. 1 is a drawing showing an antenna module according to an embodiment of the present invention.

FIG. 2 is a drawing showing a process for forming an antenna pattern according to an embodiment of the present invention.

FIG. 3 is a drawing showing a process for forming a first injection-molded part according to an embodiment of the present invention.

FIG. 4 is a drawing showing a process for forming a second injection-molded part according to an embodiment of the present invention.

FIG. 5 is a drawing showing a first embodiment of a protrusion portion of a first injection-molded part according to an embodiment of the present invention.

FIG. 6 is a drawing showing a second embodiment of a protrusion portion of a first injection-molded part according to an embodiment of the present invention.

FIG. 7 is a drawing showing a third embodiment of a protrusion portion of a first injection-molded part according to an embodiment of the present invention.

FIG. 8 is a drawing showing detailed structure of a case for a mobile terminal according to an embodiment of the present invention.

FIG. 9 is a drawing showing an antenna module according to another embodiment of the present invention.

FIG. 10 is a drawing showing a process for forming a first injection-molded part according to an embodiment of the present invention.

FIG. 11 is a drawing showing a process for forming an antenna pattern on an upper portion of a protrusion portion according to another embodiment of the present invention.

FIG. 12 is a drawing showing a process for forming a second injection-molded part according to another embodiment of the present invention.

FIG. 13 is a drawing showing an example of a mold for forming an antenna module according to an embodiment of the present invention.

FIG. 14 is a drawing showing another example of a mold for forming an antenna module according to an embodiment of the present invention.

### DETAILED DESCRIPTION OF THE EMBODIMENTS

Embodiments of the present invention will be described in detail referring to accompanying drawings hereinafter.

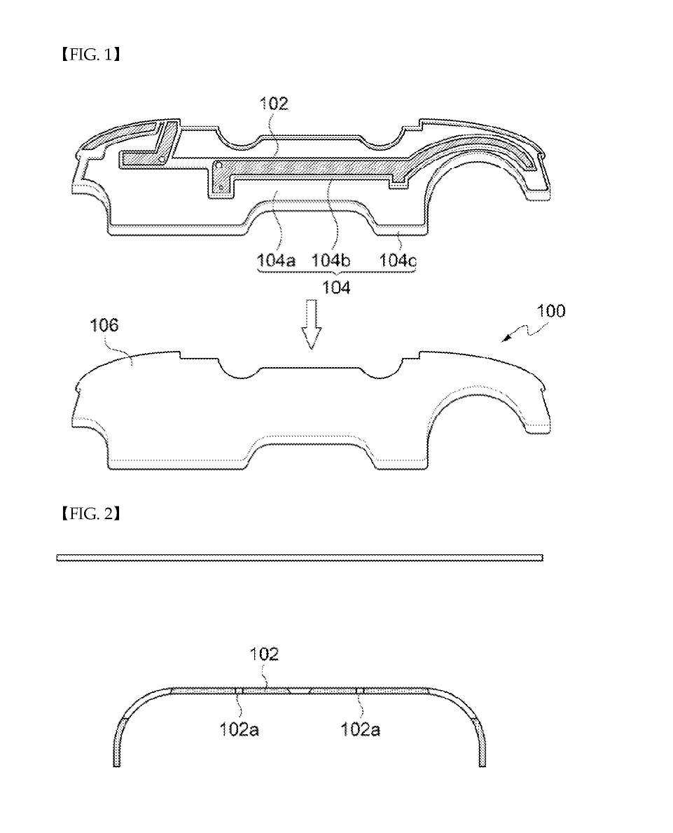

Referring to FIG. 1, an antenna module 100 according to an embodiment of the present invention includes an antenna pattern 102, a first injection-molded part 104 and a second injection-molded part 106.

The antenna pattern 102 receives signal from the outside and transmits the received signal to a signal processing unit (not shown) of a mobile terminal (not shown). For example, the antenna pattern 102 may be made of conducting material such as aluminum, copper, or iron, and may include one or more of a main antenna for transmitting/receiving, an LTE antenna, a GPS antenna, a Bluetooth antenna, a sub antenna and a Wi-Fi antenna. The antenna pattern 102 may be formed to have a planar surface or a curved surface of more than one axis, and may be formed by a press forming such as cutting and bending. The shape of the antenna pattern 102 may be variously varied depending on the frequency used in the mobile terminal, and the shape of the antenna pattern 102 is not limited to the shape shown in FIG. 1 and can be varied variously.

The first injection-molded part 104 is formed by an injection molding to have a base portion 104a and a protrusion portion 104b which is protruded therefrom.

The antenna pattern 102 is disposed on the protrusion portion 104b. In this embodiment, the antenna pattern 102 may be secured onto the protrusion portion 104b. The first injection-molded part 104 may be formed by an insert injection molding with the antenna pattern 102. The first injection-molded part 104 may be formed by an injection molding such that one surface of the antenna pattern 102 is secured thereon, and as described later the first injection-molded part 104 may be formed by an injection molding by a base mold 110 and a first cover mold 120.

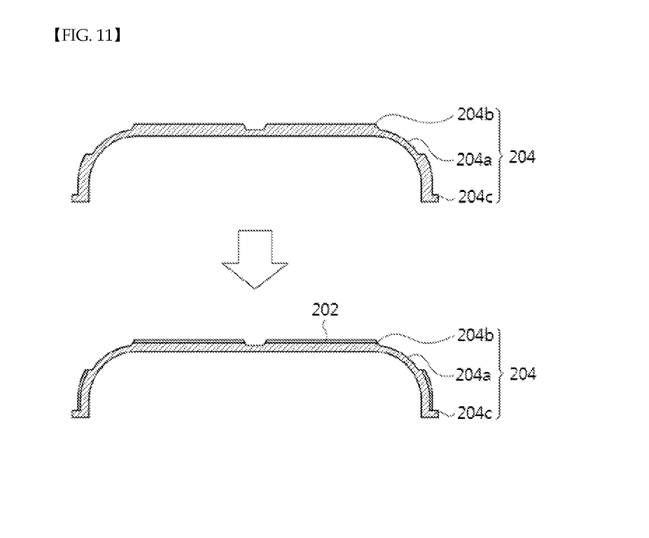

As shown in FIG. 1 (also referring to FIG. 10 to FIG. 12), the first injection-molded part 104 according to an embodiment of the present invention may include the base portion 104a, the protrusion portion 104b and an edge protrusion portion 104c.

The base portion 104a is a part of forming a base of the first injection-molded part 104, and is formed to be adjacent to the protrusion portion 104b to which the antenna pattern 102 is secured. The protrusion portion 104b is formed by being protruded from the base portion 104a, and accordingly the protrusion portion 104b forms a step from the base portion 104a.

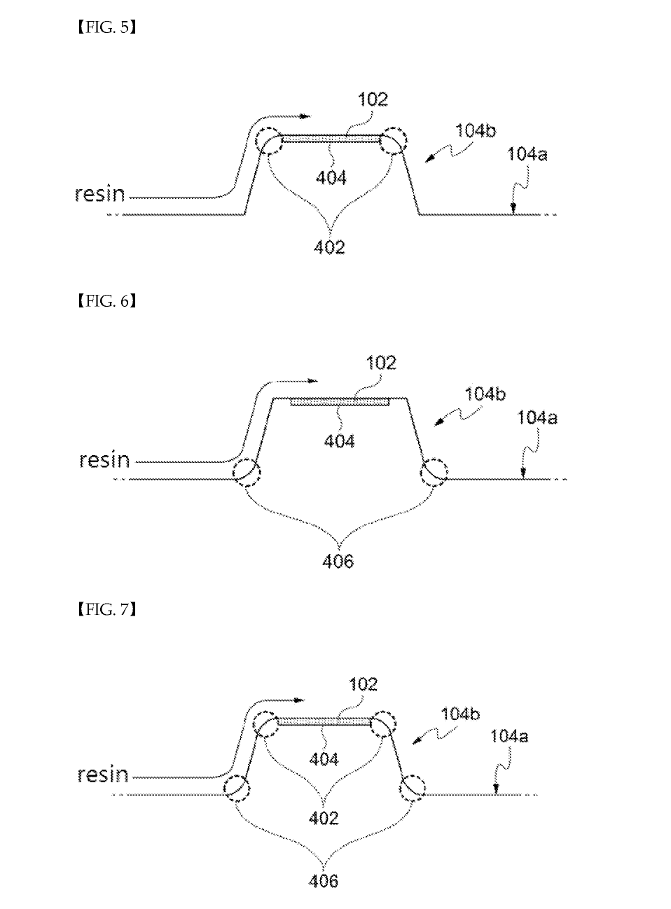

The protrusion portion 104b is a part to which one surface of the antenna pattern 102 is secured, and is formed to be protruded from the base portion 104a. Generally, in order to enhance a transmitting/receiving efficiency of an antenna, it is necessary that an antenna is apart as far as possible from a main board of a mobile terminal toward the outer direction of a mobile terminal. Accordingly, in embodiments of the present invention, one surface of the antenna patter 102 is secured on the top of the protrusion portion 104 which is protruded from the base portion 104a, the antenna patter 102 may be apart from a main board of the mobile terminal by a predetermined distance and a thickness of the second injection-molded part 106 which is formed on the antenna pattern 102 can be minimized. Since one surface of the antenna pattern 102 is secured onto the protrusion portion 104b, the antenna pattern 102 may also be at least partly inserted inside the protrusion portion 104b. Here, for example, a protrusion height of the protrusion portion 104b may be less than the whole thickness of the antenna module 100 or the mobile terminal case 200. That is, the thickness of the protrusion portion 104b is less than the whole thickness of the antenna module 100 or the mobile terminal case 200 after the second injection molding such that the protrusion portion 104b is not exposed outside the antenna module 100 or the mobile terminal case 200. For example, an upper surface of the protrusion portion 104b may be protruded from the base portion 104a to be spaced more than 0.1 mm in a downward direction (i.e., direction toward the inside of the second injection-molded part 106) from an upper surface of the second injection-molded part 106. In other words, the protrusion portion 104b is protruded to have a distance of more than 0.1 mm from an upper surface of the second injection-molded part 106. If the protrusion 104b is protruded to have a distance of less than 0.1 mm from the upper surface of the second injection-molded part, it may be difficult to form a thin film by injection molding during the second injection molding due to the protrusion portion. According to embodiments of the present invention, it is possible to make the antenna module 100 which is thin, light-weight and slim, and at the same time it is also possible to maximize the transmitting/receiving efficiency of an antenna. Detailed structures and embodiments of the protrusion portion 104b will be described later referring to FIG. 5 to FIG. 7.

The edge protrusion portion 104c may guide a position of a downward movement of a second cover mold 130 in order to obtain smooth coupling of the first injection-molded part 104 and the second injection-molded part 106 during the second injection molding process. Further, the edge protrusion portion 104c may be formed along the entire edge of the first injection-molded part 104, so that resin which is injected during the injection molding process of the second injection-molded part 106 can be prevented from being leaked from the first injection-molded part 104.

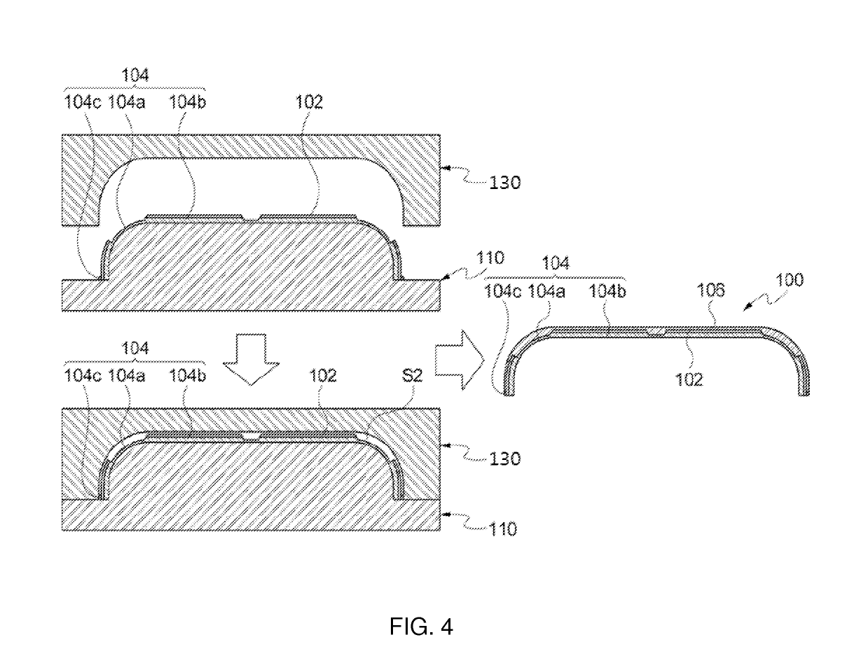

That is, the edge protrusion portion 104c is formed by being protruded at an edge area of the first injection-molded part 104, and the second cover mold 130, which will be explained later, can be landed onto the edge protrusion portion 104c. In case that the second cover mold 130 is landed onto the edge protrusion portion 104c, the gap between the first injection-molded part 1409 and the second cover mold 130 is sealed from the outside. Accordingly, resin which is injection into the gap during the injection molding process of the second injection-molded part 106 can be prevented from being leaked to the outside. This will be explained in detail referring to FIG. 4 later.

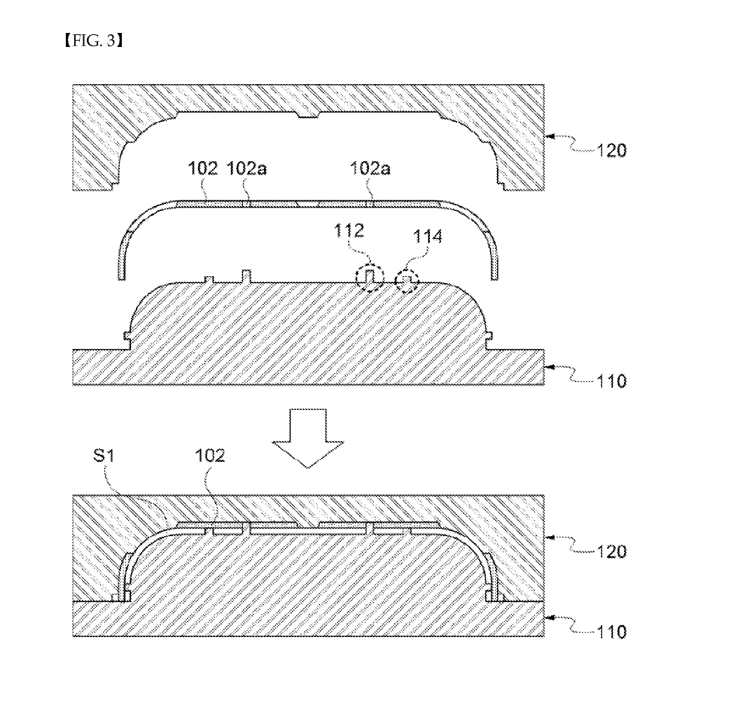

The second injection-molded part 106 is a structure which is formed by injection molding so as to cover the other surface of the antenna patter 102. After the first injection-molded part 104 is formed by the first injection molding process, the second injection-molded part 106 can be formed by a double injection molding during the second injection molding process. As described later, the second injection-molded part 105 may be formed by an injection molding by the base mold 110 and the second cover mold 130. Due to these processes, the antenna pattern 102 is interposed between the first injection-molded part 104 and the second injection-molded pattern 106. The second injection-molded part 106 may be formed to have a shape corresponding to the first injection-molded part 102, but it is not limited thereto. Further, as described later, the second injection-molded part 106 may be formed integrally with an outer surface of the mobile terminal case 200 or may be connected or attached to the outer surface of the mobile terminal case 200. Hereinafter, processes for forming the antenna pattern 102, the first injection-molded part 104 and the second injection-molded part 106 will be explained sequentially referring to FIG. 2 to FIG. 4 hereinafter.

FIG. 2 is a drawing showing a process for forming an antenna pattern 102 according to an embodiment of the present invention. As shown in FIG. 2, the antenna pattern 102 may be formed by a press forming of a metal sheet. Here, the metal sheet may be a sheet made of electrically conducting material having flexibility such as aluminum, copper, iron or the like. The antenna pattern 102 may be formed by cutting this metal sheet and subsequent multistage bending processes, and may have a two-dimensional or three-dimensional shape. At least one hole 102a may be formed at one surface of the antenna patter 102. A position fixing pin 112 of the base mold 110 may be inserted into the hole 102a, and accordingly the antenna pattern 102 can be fixed to the base mold 110.

FIG. 3 is a drawing showing a process of forming the first injection-molded part 104 according to an embodiment of the present invention. First, one surface of the antenna pattern 102 is secured or coupled to the base mold 110. As shown in FIG. 3, the position fixing pin 112 and a supporting protrusion pin 114 may be formed by being protruded to the base mold 110.

The position fixing pin 112 is a member for fixing the position of the antenna 102, and is inserted into the hole 102a of the antenna pattern 102 so as to prevent the antenna pattern 102 from getting out of its position. The position fixing pin 112 may be formed by being protruded from the base mold 110 at a position corresponding to the hole 102a of the antenna pattern 102. Although it is shown in FIG. 3 that the two position fixing pins 112 are formed to the base mold 110, this is only an embodiment and the number and the position of the position fixing pin 112 are not limited thereto.

The supporting protrusion pin 114 supports one surface of the antenna pattern 102. Accordingly, the antenna pattern 102 is supported by the supporting protrusion pin 114 so as to form and maintain a gap by a predetermined distance from the bottom of the base mold 110. Subsequently, resin is injected into the gap to form the first injection-molded part 104. Although it is shown in FIG. 3 that the four supporting protrusion pins 114 are formed to the base mold 110, this is only an embodiment and the number and the position of the supporting protrusion pin 114 are not limited thereto.

After one surface of the antenna pattern 102 is secured or coupled to the base mold 110, the first cover mold 120 may be positioned to be adjacent to the other surface of the antenna pattern 102. As shown in FIG. 3, the first cover mold 120 may be formed to have a concave/convex shape. For example, an area of the surface of the first cover mold 120 which corresponds to the other surface of the antenna pattern 102 may be formed to be concave and the other area of the surface of the first cover mold 120 which does not correspond to the other surface of the antenna pattern 102 may be formed to be convex. The concave area of the first cover mold 120 contacts or is adjacent to the other surface of the antenna pattern 102, and the convex area of the first cover mold 120 is adjacent to the base mold 110. Accordingly, a first space 51 having a concave/convex shape is formed between the base mold 110 and the first cover mold 120. In addition, an indentation having a predetermined size for forming the edge protrusion portion 104c may be provided at an edge of the first cover mold 120.

Subsequently, the first injection-molded part 104 having the base portion 104a and the protrusion portion 104b may be formed by injecting resin into the first space 51. Here, resin may be injected into the first space 51 through a nozzle (not shown), but means for injecting resin is not limited thereto.

FIG. 4 is a drawing for showing a process for forming the second injection-molded part 106 according to an embodiment of the present invention. After the first injection-molded part 104 is formed by injection molding through the first injection molding process, the first cover mold 120 is exchanged with the second cover mold 130 in a state that the first injection-molded part 104 is not separated from the base mold 110. Subsequently, in case that the second cover mold 130 is positioned to be adjacent to the outer surface of the antenna pattern 102, a second space S2 having a concave/convex shape is formed between the base mold 110 and the second cover mold 130. Subsequently, the second injection-molded part 106 may be formed by injecting resin into the second space S2 via a nozzle or the like. The second injection-molded part 106 may have a predetermined thickness (e.g., 0.1 to 0.5 mm) on the antenna pattern 102. According to embodiments of the present invention, since the second injection molding is performed in a state that the antenna pattern 102 is secured onto the protrusion portion 104b, the antenna module 100 can be formed to be thin, light-weight and slim, and at the same time the transmitting/receiving efficiency of the antenna can be maximized. The second injection-molded part 106 which is formed by the injection molding by the second injection molding process can be an outer surface of the antenna module 100 or the mobile terminal case 200.

Further, as described above, the edge protrusion portion 104c may be formed by being protruded at the edge area of the first injection-molded part 104. The second cover mold 130 may be landed on the outer surface of the edge protrusion portion 104c, and in such case the second space S2 is sealed from the outside. In case that the edge area is formed to have the same surface with the base portion 104a, the second cover mold 130 should be precisely located on the side surface of the first injection-molded part 104 in order to seal the second space S2 from the outside, but this is a work which should be precisely performed and is difficult. Even though the second cover mold 130 is precisely located to the side surface of the first injection-molded part 104, resin which is injected into the second space S2 during the injection molding process for the second injection-molded part 106 may be leaked to the outside if there is any minute gap between the base mold 110 and the second cover mold 130, and this may cause a defection of an injection molding such as burr. Accordingly, in order to solve the problem that the coupling between the first injection-molded part 104 and the second injection-molded part 106 is not smoothly coupled, the embodiments of the present invention are configured such that the edge protrusion portion 104c is formed by being protruded at the edge area of the first injection-molded part 104, and the above problem can be solved by this configuration.

FIG. 5 to FIG. 7 are drawings respectively showing a first embodiment, a second embodiment and a third embodiment of the protrusion portion 104b in the first injection-molded part 104 according to an embodiment of the present invention.

As described above, resin should be injected into the second space S2 of FIG. 4 in order to form the second injection-molded part 106. At this time, the injected resin moves from the base portion 104a along the periphery (side surface) of the protrusion portion 104b and then covering the other surface of the antenna pattern 102. In case that the protrusion portion 104b is composed of a combination of a plurality of planar surfaces, the flowing of the injected resin is disturbed due to an angled shape of the corner while the resin is moving the corner (border area where respective planar surfaces are adjacent to one another). In addition, in case of increasing the injection pressure in order to solve this problem, there may be defection in an injection molding of occurrence of burr due to the increased injection pressure. In order to solve this problem, the embodiments of the present invention the protrusion portion 104b is formed with a combination of curved surface portions 402 and 406 and a planar surface portion 404.

FIG. 5 is a drawing showing a first embodiment of the protrusion portion 104b in the first protrusion portion 104 according to an embodiment of the present invention. As shown in FIG. 5, the protrusion portion 104b may be formed to be protruded by a predetermined height from the base portion 104a, and may be formed with a combination of an upper curved surface portion 402 and a planar surface portion 404.

The upper curved surface portion 402 may be disposed to be adjacent to the antenna pattern 102 and may be formed at the periphery (side surface) of the protrusion portion 104b. Since the upper curved surface portion 402 is formed at the periphery of the protrusion portion 104b which is adjacent to the antenna pattern 102, flowing of resin moving from the periphery of the protrusion portion 104b toward the planar surface portion 404 and flowing of resin moving from the planar surface portion 404 toward the protrusion portion 104b can be easier. That is, according to embodiments of the present invention, the periphery of the protrusion portion 104b which is adjacent to the antenna pattern 102 is formed as a curved surface, flowing of resin can be easier, and accordingly it is not needed to increase the injection pressure so that the defect in an injection molding (e.g., occurrence of burr) can be minimized.

The planar surface portion 404 is a part where one surface of the antenna pattern 102 is secured or inserted, and may be formed to be flat. The planar surface portion 404 may be formed to be adjacent to the upper curved surface portion 402.

In addition, as shown in FIG. 5, an area of section of the protrusion portion 104b perpendicular to the protruding direction can be decreased as it goes toward the protruding direction from the base 104b. That is, the periphery of the protrusion portion 104b may be inclined toward inward direction of the protruding direction of the protrusion portion 104b. Accordingly, in spite of the step between the base portion 104a and the protrusion portion 104b, resin injected during the second injection molding can easily move along the periphery of the protrusion portion 104b from the base portion 104a. At this time, the area of sections perpendicular to the protruding direction of the protrusion portion 104b may linearly decrease. That is, as the height of the protrusion 104b increases, the area of the sections perpendicular to the protruding direction of the protrusion portion 104b may decrease at a constant ratio. However, this is only an embodiment, the area of the sections perpendicular to the protruding direction of the protrusion portion 104b may also nonlinearly decrease. For example, as the height of the protrusion 104b increases, the area of the sections perpendicular to the protruding direction of the protrusion portion 104b may decrease in a shape of a quadratic function.

FIG. 6 is a drawing showing a second embodiment of the protrusion portion 104b in the first protrusion portion 104 according to an embodiment of the present invention. As shown in FIG. 6, the protrusion portion 104b may be formed with a combination of a planar surface portion 404 and a lower curved surface portion 406.

The lower curved surface portion 406 may be adjacent to the base portion 104a and may be formed at the periphery of the protrusion portion 104b. The lower curved surface portion 406 can make the flowing of resin moving from the base portion 104a toward the periphery of the protrusion portion 104b and the flowing of resin moving from the periphery of the protrusion portion 104b toward the base portion 104a easier. That is, according to embodiments of the present invention, since the periphery of the protrusion portion 104b which is adjacent to the base portion 104a is formed in a curved shape, the flowing of resin can be easier, and accordingly it is not needed to increase the injection pressure and the defect (e.g., occurrence of burr) of injection molding can be minimized. The remained features of FIG. 6 are identical to those as described above, so detailed description thereof will be omitted.

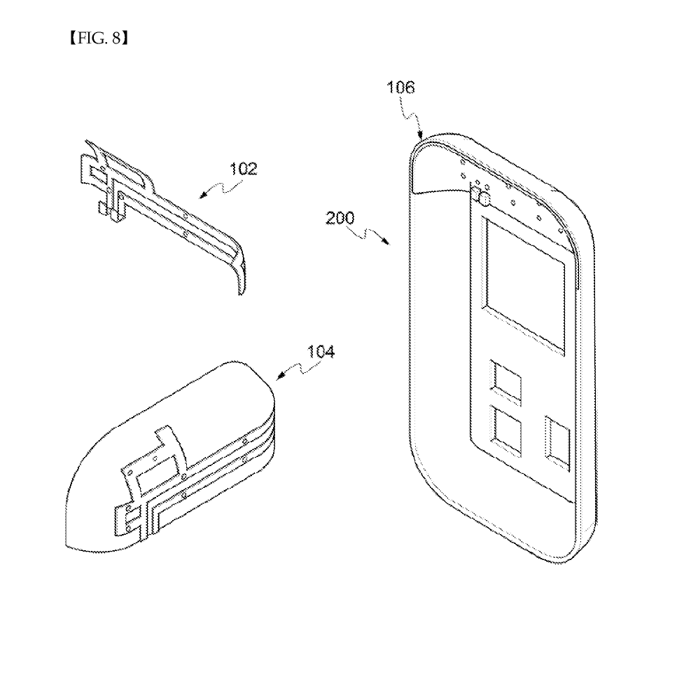

FIG. 7 is a drawing showing a third embodiment of the protrusion portion 104b in the first protrusion portion 104 according to an embodiment of the present invention. As shown in FIG. 7, the protrusion portion 104b may be formed with a combination of an upper curved surface portion 402, a planar surface portion 404 and a lower curved surface portion 406. As described above, the upper curved surface portion 402 may be adjacent to the antenna pattern 102 and may be formed at the periphery of the protrusion portion 104b, and the lower curved surface portion 406 may be adjacent to the base portion 104a and may be formed at the periphery of the protrusion portion 104b. Resin which is injected during the second injection molding process moves sequentially along the base portion 104a, the lower curved surface portion 406, the periphery of the protrusion portion 104b, the upper curved surface portion 402 and the planar part 404, and then sequentially moves along the upper curved surface portion 402, the periphery of the protrusion 104b, the lower curved surface portion 406 and the base portion 104a. By such processes, the flowing of resin which is injected during the second injection molding process can made easier.

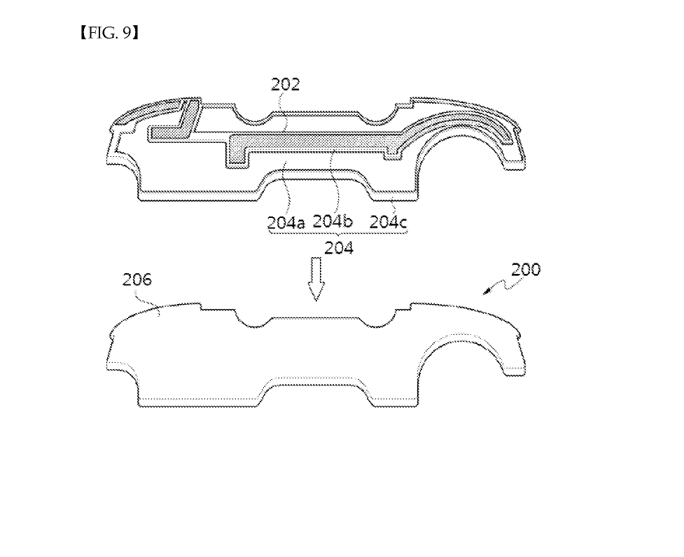

FIG. 8 is a drawing showing detailed structure of a mobile terminal case 200 according to an embodiment of the present invention. As shown in FIG. 8, the mobile terminal case 200 includes the antenna pattern 102, the first injection-molded part 104 and the second injection-molded part 106. The antenna pattern 102, the first injection-molded part 104 and the second injection-molded part 106 of FIG. 8 are identical to those of FIG. 1 to FIG. 7. Here, the second injection-molded part 106 may be formed integrally with the outer surface of the mobile terminal case 200. Further, the second injection-molded part 106 may be connected or coupled to the outer surface of the mobile terminal case 200. The connection or coupling may be performed by various methods such as a screw coupling method, a locking connection method, a forcibly fitting method, a bonding method or the like.

Meanwhile, the first injection-molded part 104 may be formed integrally with the mobile terminal case 200, and the second injection-molded part 106 may be formed as an injection-molded part which is added to a portion or the whole of the first injection-molded part 104.

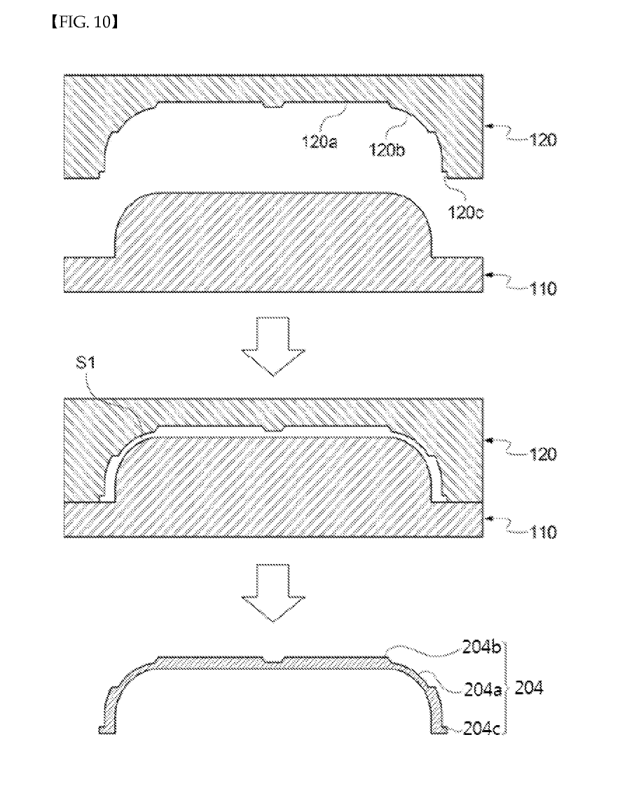

An antenna module according to another embodiment of the present invention will be hereinafter described referring to FIG. 9 to FIG. 12.

Referring to FIG. 9, the antenna module 200 according to another embodiment of the present invention includes a first injection-molded part 202, an antenna pattern 204 and a second injection-molded part 206. Explanations for parts of the first injection-molded part 202, the antenna pattern 204 and the second injection second injection-molded part 206 which are identical to those of the above-described embodiments will be omitted.

FIG. 10 is a drawing showing processes for forming the first injection-molded part 204 according to an embodiment of the present invention. As shown in FIG. 10, for the forming of the first injection-molded part 204, the base mold 110 and the first cover mold 120 may be provided. One surface of the first cover mold 120 may be formed to include a concave/convex shape. For example, one surface of the first cover mold 120 may be formed to have a concave portion 120a and 120c and a convex portion 120b. In case that one surface of the first cover mold 120 is adjacent to the base mold 110, a first space S1 having a concave/convex shape is formed between the base mold 110 and the first cover mold 120. Subsequently, the first injection-molded part 204 may be formed by an injection molding by injecting resin into the first space S1. Here, the convex portion 120b of the first cover mold 120 forms the base portion 204a of the first injection-molded part 204, and the concave portion 120a of the first cover mold 120 forms the protrusion portion 204b of the first injection-molded part 204. In addition, other concave portion 120c of the first cover mold 120 forms the edge protrusion portion 204c of the first injection-molded part 204. Meanwhile, resin may be injected into the first space S1 through a nozzle (not shown), but means for injecting resin is not limited thereto.

FIG. 11 is a drawing showing processes for forming an antenna pattern 202 on the top of the protrusion portion 204b according to an embodiment of the present invention. As described above, the antenna pattern 202 may be formed on the top of the protrusion portion 204b by an LDS (laser direct structuring) method or a metal printing method. For example, the antenna pattern 204 may be formed by irradiating laser on top of the protrusion portion 204b and coating metal on the area where the laser is irradiated, or by printing electrically conductive material on the protrusion portion 204b.

LDS method is one of various methods for forming the antenna pattern 102, and compared to other methods cost for developing and manufacturing is low and it is easy to change micro pattern (micro circuit). First, a laser may be irradiated on the top of the protrusion portion 204b. The laser may be irradiated onto the top of the protrusion portion 204b corresponding to the shape of the antenna pattern 202 to be formed. Here, the top of the protrusion portion 204b means the portion of the protrusion portion 204b which are located at the side of the protruding direction. Subsequently, the antenna pattern 202 may be formed by coating metal material on the area where the laser is irradiated. At this time, for example, the metal material may include at least one of copper, nickel and gold, and a plurality of metal materials can be sequentially coated on the area where the laser is irradiated. For example, copper may be firstly coated on the area where the laser is irradiated, nickel may be secondly coated, and the gold may be thirdly coated. In addition, gold may be coated partly or entirely on the area where copper and nickel are coated. By such processes, the antenna pattern 202 may be formed on the top of the protrusion portion 204b.

Meanwhile, the metal printing method is a method of forming the antenna pattern 202 by printing (used as a meaning including “attaching”) electrically conductive material, e.g., electrically conductive ink (or paint) on the top of the protrusion portion 204b, and has an advantage that a printing process is very simple so as to substantially improve productivity and it is possible to form patterns of various shapes. At this time, the electrically conductive material may include at least one of gold, silver, copper, and nickel. Since a detailed method for printing the electrically conductive material is well known in the art, detailed explanation thereof will be omitted.

Meanwhile, although a process for forming the antenna pattern 202 may be performed after the first injection-molded part 204 is separated from the base mold 110, it is not limited thereto and this process may also be possible to be performed in a state that the first injection-molded part 204 is not separated from the base mold 110.

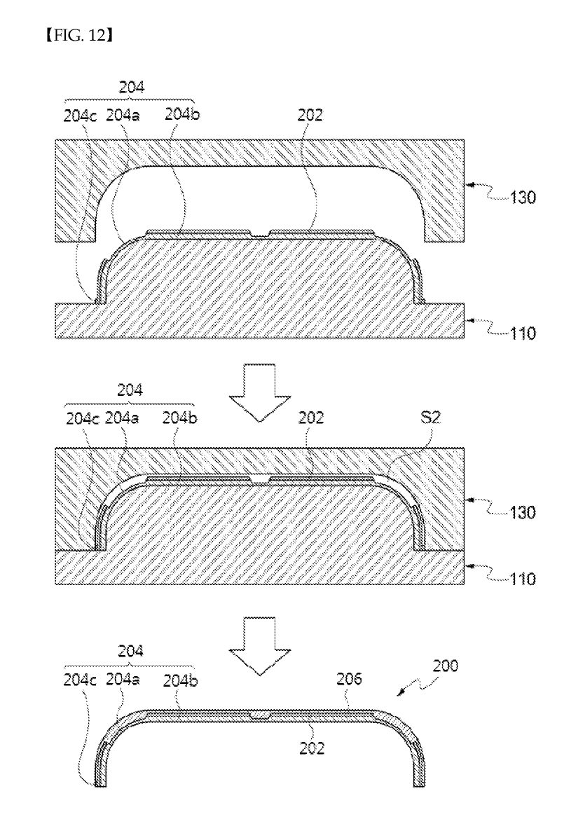

FIG. 12 is a drawing showing a process for forming the second injection-molded part 206 according to an embodiment of the present invention. As shown in FIG. 12, for the forming of the second injection-molded part 206, the base mold 110 and the second cover mold 130 may be provided. As stated above, it is possible to form the antenna pattern 202 in a state that the first injection-molded part 204 is not separated from the base mold 110, and in this case the base mold 110 is reused while the second injection-molded part 206 is formed.

As shown in FIG. 12, in case that one surface of the second cover mold 130 approaches the base mold 110, the second space S2 is formed between the base mold 110 and the second cover mold 130. Subsequently, the second injection-molded part 206 may be formed by an injection molding by injecting resin into the second space S2 through a nozzle. The second injection-molded part 206 may have a predetermined thickness (e.g., 01. To 0.5 mm) on the antenna pattern 202. According to embodiments of the present invention, since the second injection molding is performed in a state that the antenna pattern 202 is formed on the top of the protrusion portion 204b, the antenna module 100 can be formed to be thin, light-weight and slim, and at the same time the transmitting/receiving efficiency of the antenna can be maximized. The second injection-molded part 206 may be the outer surface of the antenna module 100 or the mobile terminal case 200.

Further, as described above, the edge protrusion portion 204c may be formed at the edge area of the first injection-molded part 204. The second cover mold 130 may be landed on the outer surface of the edge protrusion portion 204c, and in such case the second space S2 is sealed from the outside. In case that the edge area is formed to have the same surface with the base portion 204a, the second cover mold 130 should be precisely located on the side surface of the first injection-molded part 204 in order to seal the second space S2 from the outside, but this is a work which should be precisely performed and is difficult. Even though the second cover mold 130 is precisely located to the side surface of the first injection-molded part 204, resin which is injected into the second space S2 during the injection molding process for the second injection-molded part 206 may be leaked to the outside if there is any minute gap between the base mold 110 and the second cover mold 130, and this may cause a defection of an injection molding such as burr. Accordingly, in order to solve the problem that the coupling between the first injection-molded part 204 and the second injection-molded part 206 is not smoothly coupled, the embodiments of the present invention are configured such that the edge protrusion portion 204c is formed by being protruded at the edge area of the first injection-molded part 204, and the above problem can be solved by this configuration.

Meanwhile, according to an embodiment of the present invention, the second injection-molded part may be formed in a state that the first injection-molded is not separated from the base mold after the first injection-molded part is formed.

For example, after forming the first injection-molded part by an insert injection molding using the antenna pattern, the second injection-molded part may be formed in a state that the first injection-molded part is not separated from the base mold, and in another example, after forming the first injection-molded part by an injection molding, the antenna pattern may be formed on the protrusion portion of the first injection-molded part in a state that the first injection-molded part is not separated from the base mold, and subsequently the second injection-molded part may be formed thereon.

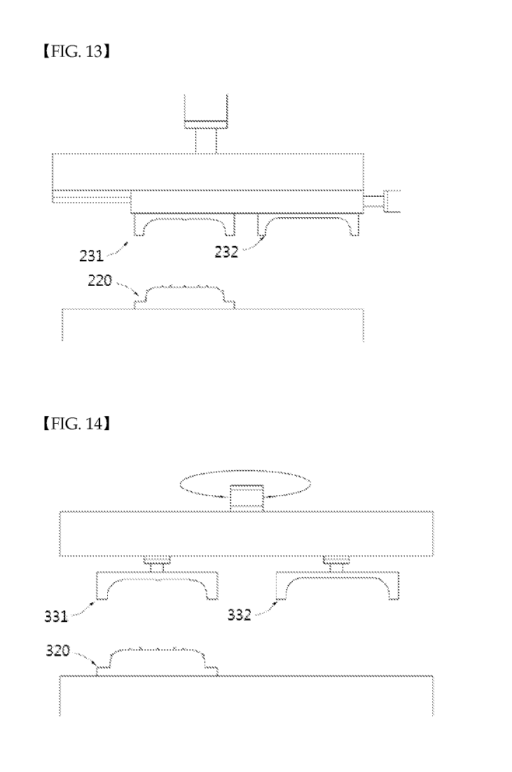

For this, the cover molds 231 and 232 may be configured to linearly move as shown in FIG. 13, and may alternatively be configured to rotate as shown in FIG. 14.

That is, in case of FIG. 13, the first injection-molded part is formed by the combination of the base mold 220 and the first cover mold 231, and then after the first cover mold 231 is removed, the first cover mold 231 and the second cover mold 233 linearly move in a state that the first injection-molded part is secured to the base mold 220, and subsequently the second injection-molded part is formed by the combination of the base mold 220 and the second cover mold 233. Meanwhile, in case of FIG. 14, the first injection-molded part is formed by the combination of the base mold 320 and the first cover mold 331, and then after the first cover mold 331 is removed, the first cover mold 331 and the second cover mold 333 rotates in a state that the first injection-molded part is secured to the base mold 320, and subsequently the second injection-molded part is formed by the combination of the base mold 320 and the second cover mold 333.

Since the second injection-molded part is formed in a state that the formed first injection-molded part is not separated from the base mold, damages which may be caused while the injection-molded part is separated from the mode and is again inserted into the mold can be minimized.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. An antenna module comprising:
a first injection-molded part which is formed to have a base portion and a protrusion portion to be protruded from the base portion by an injection molding;
an antenna pattern which is positioned on the protrusion portion; and
a second injection-molded part which is formed to cover the antenna pattern by an injection molding.

2. The antenna module of claim 1, wherein the first injection molded-part is formed in an insert injection molding using the antenna pattern.

3. The antenna module of claim 1, wherein the antenna pattern is formed by irradiating a laser on a top of the protrusion portion and coating metal material on an area where the laser is irradiated or by printing an electrically conductive material on the top of the protrusion portion.

4. The antenna module of claim 1, wherein the protrusion portion is formed by a combination of a curved surface portion and a planar surface portion.

5. The antenna module of claim 4, wherein the curved surface portion comprises an upper curved surface portion which is adjacent to the antenna patter and is formed at a periphery of the protrusion portion.

6. The antenna module of claim 5, wherein the curved surface portion further comprises a lower curved surface portion which is adjacent to the base portion and is formed at the periphery of the protrusion portion.

7. The antenna module of claim 1, wherein the protrusion portion is formed such that an area of a section perpendicular to a protrusion direction of the protrusion portion decreases as it goes toward the protrusion direction of the protrusion portion from the base portion.

8. The antenna module of claim 7, wherein the area of the perpendicular section nonlinearly decreases.

9. The antenna module of claim 7, wherein the area of the perpendicular section linearly decreases.

10. The antenna module of claim 1, wherein the antenna pattern comprises at least one of a main antenna for transmitting/receiving, an LTE antenna, a GPS antenna, a Bluetooth antenna, a sub antenna, and a Wi-Fi antenna.

11. The antenna module of claim 1, wherein an edge protrusion portion is formed by being upwardly protruded at an edge area of the first injection-molded part.

12. The antenna module of claim 1, wherein the second injection-molded part is formed by an injection molding in a state the formed first injection-molded part is not separated from a base mold.

13. A method for forming an antenna module comprising:
forming a first injection-molded part by an insert injection molding using an antenna pattern; and
forming a second injection-molded part which covers the antenna pattern by an injection molding,
wherein the first injection-molded part comprises a base portion and a protrusion portion which is protruded from the base portion,
and wherein the antenna pattern is formed on the protrusion portion.

14. The method of claim 13, wherein the second injection-molded part is formed by an injection molding in a state that the formed first injection-molded part is not separated from a base mold.

15. The method of claim 13, wherein a hole is provided to the antenna pattern, and the base mold is provided with a position fixing pin which is inserted into the hole during the insert molding to fix position of the antenna pattern.

16. The method of claim 13, wherein the base mold is provided with a supporting protrusion pin which supports the antenna pattern during the insert molding.

17. A method for forming an antenna module comprising:
forming a first injection-molded part having a base portion and a protrusion portion which is protruded from the base portion;
forming an antenna pattern on the protrusion portion; and
forming a second injection-molded part which covers the antenna pattern by an injection molding.

18. The method of claim 17, wherein the antenna pattern is formed by irradiating a laser on a top of the protrusion portion and coating metal material on an area where the laser is irradiated or by printing an electrically conductive material on the top of the protrusion portion.

19. The method of claim 17, wherein the second injection-molded part is formed by an injection molding in a state the formed first injection-molded part is not separated from a base mold.
